(19) United States
(12) Patent Application Publication
(10) Pub. No.: US 2025/0063040 A1
(43) Pub. Date: Feb. 20, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Akihide OSHIMA, Kanagawa (JP)

(73) Assignee: FUJIFILM Business Innovation Corp., Tokyo (JP)

(21) Appl. No.: 18/519,297

(22) Filed: Nov. 27, 2023

(30) Foreign Application Priority Data
Jun. 16, 2023 (JP) 2023-099658

(51) Int. Cl. H04L 9/40

(52) U.S. Cl. CPC H04L 63/083

(57) ABSTRACT

An information processing system includes a first interface, a second interface, and a processor, wherein the processor is configured to: connect the first interface to a first network allowing any terminal to connect; connect the second interface to a second network allowing a specific terminal to connect; make identification information available for acquisition by a terminal connected to the first network, the identification information being used to identify an executing device that executes a predetermined process as the specific terminal connected to the second network; and transmit, upon accepting the identification information and an execution instruction to execute the process from a terminal connected to the first network, the execution instruction over the second network to the executing device pertaining to the identification information.

### CROSS-REFERENCE TO RELATED APPLICATIONS

This application is based on and claims priority under 35 USC 119 from Japanese Patent Application No. 2023-099658 filed Jun. 16, 2023.

### BACKGROUND

### (i) Technical Field

The present disclosure relates to an information processing system, an information processing method, and a non-transitory computer readable medium.

### (ii) Related Art

Japanese Unexamined Patent Application Publication (Translation of PCT Application) No. 2017-533642 discloses a method for operating a user equipment device in a private network by a visiting device from outside the private network, each device being connected to network functions on a common server outside the private network via a server gateway, the method including: (i) a step for creating and managing a private network context for both the user equipment device and the visiting device using the network functions for each, the private network context defining, for each device, a set of parameters that affect interaction between each device and private content and/or services; (ii) a step for authenticating the user equipment device and the visiting device by referencing one or more databases defined by the network functions, and then determining whether the user equipment device and the visiting device are allowed to bind the private contexts; and, if allowed to bind the private contexts, (iii) a step for configuring connections between network functions on the server to bind the private contexts of the user equipment device and the visiting device, thereby enabling interaction between the devices.

### SUMMARY

Given a first network allowing any terminal to connect and a second network allowing a specific terminal to connect, for example, due to the different security policies, a terminal connected to the first network may not be able to give a process execution instruction to an executing device as a specific terminal connected to the second network, and the executing device may not be able to execute the process.

Aspects of non-limiting embodiments of the present disclosure relate to enabling a process to be executed according to an execution instruction from a terminal connected to a first network allowing any terminal to connect, the process being executed by an executing device connected to a second network allowing a specific terminal to connect.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a first interface, a second interface, and a processor, wherein the processor is configured to: connect the first interface to a first network allowing any terminal to connect; connect the second interface to a second network allowing a specific terminal to connect; make identification information available for acquisition by a terminal connected to the first network, the identification information being used to identify an executing device that executes a predetermined process as the specific terminal connected to the second network; and transmit, upon accepting the identification information and an execution instruction to execute the process from a terminal connected to the first network, the execution instruction over the second network to the executing device pertaining to the identification information.

### BRIEF DESCRIPTION OF THE DRAWINGS

An exemplary embodiment of the present disclosure will be described in detail based on the following figures, wherein:

FIG. 1 is a schematic diagram illustrating an executing system according to an exemplary embodiment;

FIG. 2 is a block diagram illustrating an example of a hardware configuration of an executing device according to the exemplary embodiment;

FIG. 3 is a block diagram illustrating an example of a functional configuration of a control device of the executing device according to the exemplary embodiment;

FIG. 3 is a block diagram illustrating an example of a hardware configuration of a terminal according to the exemplary embodiment;

FIG. 5 is a block diagram illustrating an example of a functional configuration of the terminal according to the exemplary embodiment;

FIG. 6 is a block diagram illustrating an example of a hardware configuration of a multi-function device according to the exemplary embodiment;

FIG. 7 is a block diagram illustrating an example of a functional configuration of a control device of the multi-function device according to the exemplary embodiment; and

FIG. 8 is a flowchart illustrating an example of the flow of an execution process according to the exemplary embodiment.

### DETAILED DESCRIPTION

Hereinafter, an exemplary embodiment of the present disclosure will be described on the basis of the drawings.

### <Executing System 10>

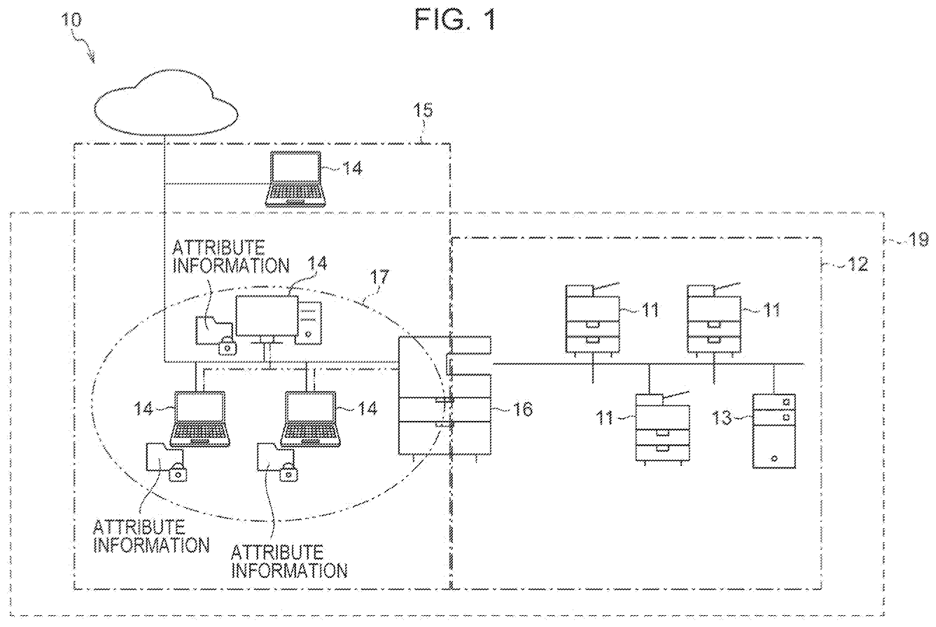

First, an executing system 10 according to the exemplary embodiment will be described. FIG. 1 is a schematic diagram illustrating the executing system 10 according to the exemplary embodiment.

The executing system 10 executes information processing, including an execution process described later, as predetermined processing. Specifically, as illustrated in FIG. 1, the executing system 10 includes multiple executing devices 11, a perimeter network 12, an authentication device 13, multiple terminals 14, a zero-trust network 15, and a multi-function device 16. The zero-trust network 15 is an example of a first network, and the perimeter network 12 is an example of a second network.

### <Executing Devices 11>

The executing devices 11 are devices that execute predetermined processing. The multiple executing devices 11 are each connected to the perimeter network 12 and are capable of communicating with each other over the perimeter network 12.

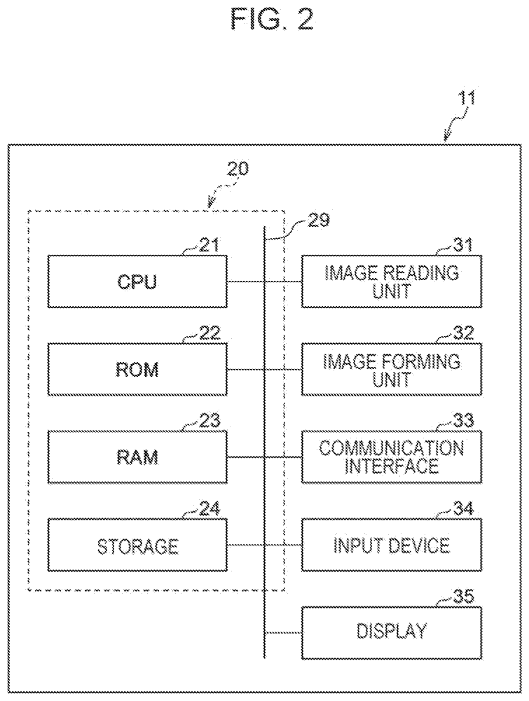

Specifically, the executing devices 11 are configured as all-in-one machines capable of executing processes such as copy, print, scan, and facsimile processes, for example. As illustrated in FIG. 2, the executing devices 11 configured as all-in-one machines are each provided with a control device 20, an image reading unit 31, an image forming unit 32, a communication interface 33, an input device 34, and a display 35.

The image reading unit 31 is a component (for example, a scanner) that reads an image of a document. The image reading unit 31 optically reads and converts an image of a document into a digital signal, thereby generating image data. Note that an image may contain text.

The image forming unit 32 is a component that forms an image onto a recording medium such as paper. The image forming unit 32 forms an image onto a recording medium according to an electrophotographic system in which the steps of charging, exposing, developing, transferring, and fusing are performed, for example. Note that the image forming unit 32 may also form an image onto a recording medium according to another system, such as an inkjet system.

The communication interface 33 is connected to the perimeter network 12, and is an interface (communication unit) for communicating with other equipment such as the executing devices 11 and the multi-function device 16 over the perimeter network 12.

In the executing devices 11, a scan process is executed by, for example, causing the image reading unit 31 to read an image of a document and generate image data. In the executing devices 11, a facsimile process is executed by, for example, transmitting image data generated by reading an image of a document with the image reading unit 31 to another piece of equipment, such as another all-in-one machine.

In the executing devices 11, a copy process is executed by, for example, causing the image forming unit 32 to form an image onto a recording medium such as paper on the basis of image data generated by reading an image of a document with the image reading unit 31. In the executing devices 11, a print process is executed by, for example, causing the image forming unit 32 to form an image onto a recording medium such as paper on the basis of image data obtained from a terminal such as a personal computer or a smartphone, from a recording medium such as USB memory, or the like.

The input device 34 is a component that accepts instructions inputted by the user. Specifically, the input device 34 is configured as input keys (such as a keyboard and operation buttons, for example) and a touch panel on which the user performs input operations, for example. Instructions given by the user may be execution instructions causing the executing device 11 to execute processes such as copy, print, scan, and facsimile processes.

The display 35 is a notification unit that displays presentation information to be presented to the user, thereby notifying the user of the presentation information. The display 35 may be configured as a liquid crystal display or an organic light-emitting diode display, for example.

Note that the display 35 may also function as the input device 34. In this case, the input device is configured as a resistive, capacitive, or other type of touch panel, and the user inputs instructions by performing touch operations, for example.

The control device 20 controls each unit of the executing device 11. The control device 20 functions as a computer, and as illustrated in FIG. 2, includes a central processing unit (CPU) 21, read-only memory (ROM) 22, random access memory (RAM) 23, and storage 24. The CPU 21, ROM 22, RAM 23, and storage 24 are interconnected by a bus 29.

The CPU 21 is a central processing unit that executes various programs, including information processing programs such as an execution process program, and controls each unit. The ROM 22 stores various programs, including information processing programs, and various data. The RAM 23 temporarily stores programs or data as a work area. The storage 24 includes a storage medium such as a hard disk drive (HDD), a solid-state drive (SSD), or flash memory, and stores various programs, including an operating system, and various data. Note that information processing programs may also be stored in the storage 24.

In the control device 20, the CPU 21 reads out various programs, including information processing programs, from the ROM 22 or the storage 24, and executes the programs while using the RAM 23 as a work area. By executing the information processing programs, the CPU 21 achieves various functions for controlling each unit of the executing device 11.

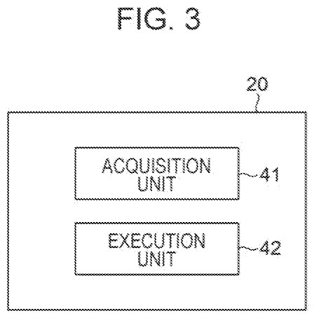

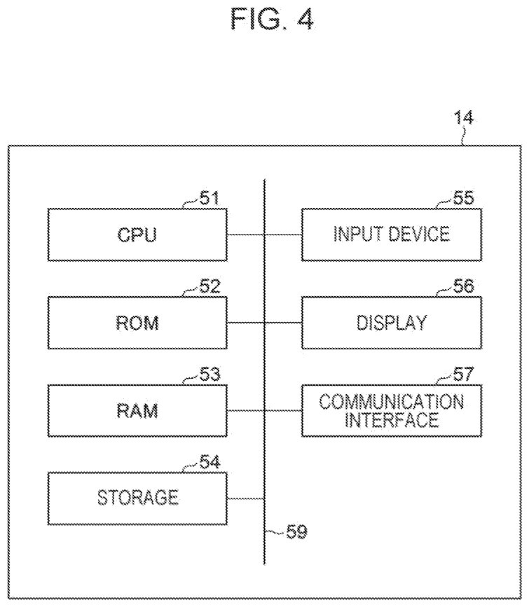

In the control device 20, the CPU 21 executes an information processing program to thereby function as an acquisition unit 41 and an execution unit 42, as illustrated in FIG. 3. The acquisition unit 41 acquires an execution instruction to execute a predetermined process. The execution unit 42 causes each unit of the executing device 11 to execute processing on the basis of an execution instruction acquired by the acquisition unit 41.

### <Perimeter Network 12 and Authentication Device 13>

The perimeter network 12 illustrated in FIG. 1 is a network that incorporates a perimeter security system, such as a firewall and a proxy. The perimeter network 12 is configured as a LAN or other local network, for example.

The authentication device 13 illustrated in FIG. 1 is an authentication server or other authentication device that manages the authentication rights of users who use the executing devices 11, and is provided on the perimeter network 12. In the exemplary embodiment, such a user uses an executing device 11 by obtaining user information such as use availability and usage rights through the executing device 11 or directly by communicating with the authentication device 13, on the basis of user account information registered in the authentication device 13.

### <Terminals 14>

The terminals 14 are devices capable of giving the executing devices 11 execution instructions to execute predetermined processes. Specifically, the terminals 14 are devices such as personal computers and smartphones. The multiple terminals 14 are each connected to the zero-trust network 15 and are capable of communicating with each other over the zero-trust network 15.

Furthermore, some of the multiple terminals 14 are connected to a blockchain network 17 built on the zero-trust network 15, and the terminals 14 connected to the blockchain network 17 are capable of communicating with each other.

Each terminal 14 functions as a computer, and as illustrated in FIG. 4, includes a central processing unit (CPU) 51, read-only memory (ROM) 52, random access memory (RAM) 53, storage 54, an input device 55, a display 56, and a communication interface 57. The CPU 51, ROM 52, RAM 53, storage 54, input device 55, display 56, and communication interface 57 are interconnected by a bus 59.

The CPU 51 is a central processing unit that executes various programs, including information processing programs, and controls each unit. The ROM 52 stores various programs and various data. The RAM 53 temporarily stores programs or data as a work area. The storage 54 includes a storage medium such as a hard disk drive (HDD), a solid-state drive (SSD), or flash memory, and stores various programs, including an operating system, and various data. Note that information processing programs may also be stored in the storage 54.

The input device 55 is a component that accepts instructions inputted by the user. Specifically, the input device 55 is configured as input keys (such as a keyboard and operation buttons, for example) and a touch panel on which the user performs input operations, for example. Instructions given by the user may be execution instructions causing the executing device 11 to execute processes such as copy, print, scan, and facsimile processes.

The display 56 is a notification unit that displays presentation information to be presented to the user, thereby notifying the user of the presentation information. The display 56 may be configured as a liquid crystal display or an organic light-emitting diode display, for example.

Note that the display 56 may also function as the input device 55. In this case, the input device is configured as a resistive, capacitive, or other type of touch panel, and the user inputs instructions by performing touch operations, for example.

The communication interface 57 is connected to the zero-trust network 15, and is an interface (communication unit) for communicating with other equipment such as other terminals 14 and the multi-function device 16 over the zero-trust network 15.

In the terminals 14, the CPU 51 reads out various programs, including information processing programs, from the ROM 52 or the storage 54, and executes the programs while using the RAM 53 as a work area. By executing the information processing programs, the CPU 51 achieves various functions.

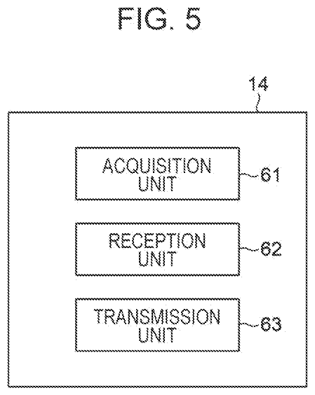

In the terminals 14, the CPU 51 executes an information processing program to thereby function as an acquisition unit 61, a reception unit 62, and a transmission unit 63, as illustrated in FIG. 5. The acquisition unit 61 acquires information such as a token as identification information used to identify an executing device 11. The reception unit 62 accepts an execution instruction directed to the executing device 11 and inputted by the user through the input device 55. The transmission unit 63 transmits the token acquired by the acquisition unit 61 and execution instruction accepted by the reception unit 62 to the multi-function device 16.

### <Zero-Trust Network 15>

The zero-trust network 15 illustrated in FIG. 1 is a network which uses an end-to-end security system and which allows any terminal on the Internet to connect.

In the end-to-end method, only two parties, namely two terminals 14 that are to communicate with each other, encrypt and decrypt the communication, thereby deterring intervention by a third party along the route, and only the terminals 14 possess and manage encryption keys, while the channel, relay system, or the like only delivers encrypted data to the other party.

Thus, in the case of using the zero-trust network 15, EDR or other endpoint security functions are to be installed, and these endpoint security functions are installed in the terminals 14.

Note that since the blockchain network 17 built on the zero-trust network 15 is a distributed, decentralized network, which makes it possible to ensure security by being trustless (no centralized method of authentication). Consequently, an authentication device such as an authentication server is unnecessary on the blockchain network 17.

### <Multi-Function Device 16>

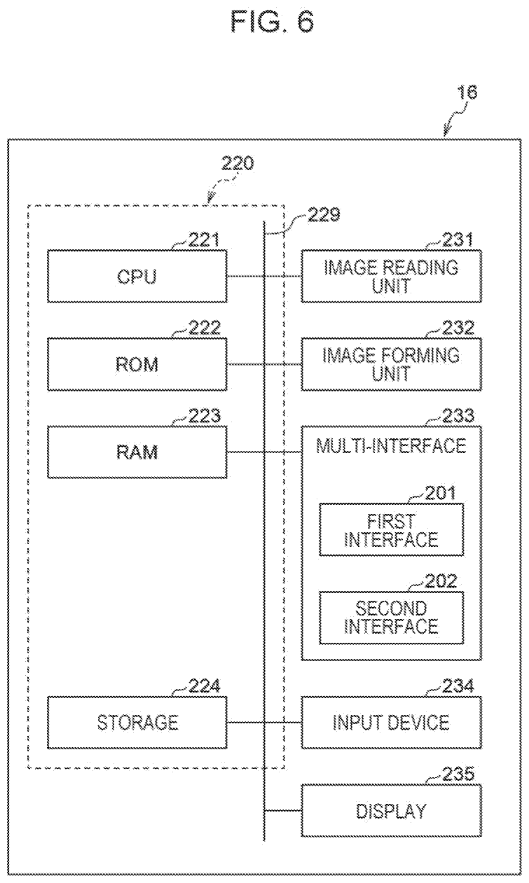

The multi-function device 16 is an example of an information processing system, and may also be referred to as an information processing device that processes information. Specifically, like the executing devices 11, the multi-function device 16 is configured as an all-in-one machine capable of executing processes such as copy, print, scan, and facsimile processes, for example. As illustrated in FIG. 6, the multi-function device 16 configured as an all-in-one machine is provided with a control device 220, an image reading unit 231, an image forming unit 232, a multi-interface 233, an input device 234, and a display 235.

The control device 220 functions as a computer, and as illustrated in FIG. 6, includes a central processing unit (CPU) 221, read-only memory (ROM) 222, random access memory (RAM) 223, and storage 224. The CPU 221, ROM 222, RAM 223, and storage 224 are interconnected by a bus 229.

The control device 220, image reading unit 231, image forming unit 232, input device 234, display 235, CPU 221, ROM 222, RAM 223, storage 224, and bus 229 in the multi-function device 16 are configured similarly to the control device 20, image reading unit 31, image forming unit 32, input device 34, display 35, CPU 21, ROM 22, RAM 23, storage 24, and bus 29 in the executing devices 11.

The multi-interface 233 is a communication interface (communication unit) including a first interface 201 and a second interface 202. The first interface 201 is connected to the zero-trust network 15, and is an interface (communication unit) for communicating with other equipment such as the terminals 14 over the zero-trust network 15. The second interface 202 is connected to the perimeter network 12, and is an interface (communication unit) for communicating with other equipment such as the executing devices 11 over the perimeter network 12.

Note that the second interface 202 may be capable of communicating with the perimeter network 12 by a wireless communication function such as Wi-Fi (R) or Bluetooth (R).

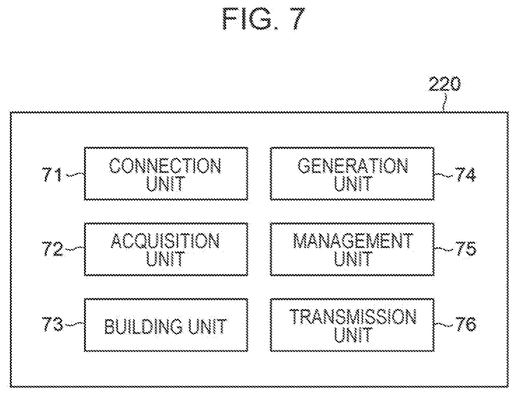

In the control device 220, the CPU 221 executes an information processing program to thereby function as a connection unit 71, an acquisition unit 72, a building unit 73, a generation unit 74, a management unit 75, and a transmission unit 76, as illustrated in FIG. 7.

The connection unit 71 connects the first interface 201 to the zero-trust network 15 and connects the second interface 202 to the perimeter network 12.

The acquisition unit 72 acquires device information (such as the host name, IP address, MAC address, capacity, status, and rights information, for example) for each of the executing devices 11, and stores the acquired device information in the storage 224 or the like.

The building unit 73 builds the blockchain network 17 on the zero-trust network 15. Specifically, for example, the building unit 73 defines 0th block information in a file or the like, initializes a blockchain on the basis of the file, and activates the blockchain with a private network ID to build the blockchain network 17 as a logical private network.

The generation unit 74 generates tokens for each of the executing devices 11 connected to the perimeter network 12. The tokens are transferable between the terminals 14 on the zero-trust network 15, and the terminals 14 in a building 19 of an organization (for example, a company) may refer to a list of tokens (hereinafter referred to as a token list in some cases) generated by the generation unit 74 when the terminals 14 join the blockchain network 17.

The generation unit 74 may generate non-fungible tokens resistant or immune to tampering as the tokens. Furthermore, the generation unit 74 may generate tokens in which usage restrictions on the executing devices 11 are set. Specifically, for example, a token may be generated for each process (specifically, processes such as copy, print, scan, and facsimile processes) that an executing device 11 is allowed to execute. The generation unit 74 may also generate tokens with a time of use set (for example, available for use from 10:00 to 12:00).

The management unit 75 makes the list of tokens associated with each executing device 11 available for acquisition by the terminals 14 connected to the zero-trust network 15 (specifically, the blockchain network 17) as identification information identifying each executing device 11.

Note that when usage restrictions on the executing devices 11 are set in the tokens, the management unit 75 makes the token list, in which usage restrictions on the executing devices 11 are set, available for acquisition by the terminals 14 connected to the zero-trust network 15.

The transmission unit 76, upon accepting a token and a process execution instruction from a terminal 14 connected to the zero-trust network 15 (specifically, the blockchain network 17), transmits the execution instruction over the perimeter network 12 to the executing device 11 associated with the token.

Specifically, the transmission unit 76, upon accepting a token and a process execution instruction from a terminal 14 connected to the blockchain network 17, transmits the execution instruction over the perimeter network 12 to the executing device 11 associated with the token within the scope of the rights permitting use of the executing device 11 by the terminal 14, on the basis of attribute information in the terminal 14.

In this case, each terminal 14 connected to the blockchain network 17 maintains an information instance describing attribute information and the like pertaining to the terminal 14 itself. The information is managed in a decentralized manner on the blockchain network 17. The information that may be maintained in the information instance may be a private key. The private key may be used to restrict available processes and services, and to set conditions such as the time of day when use is available.

### <Action of Executing System 10>

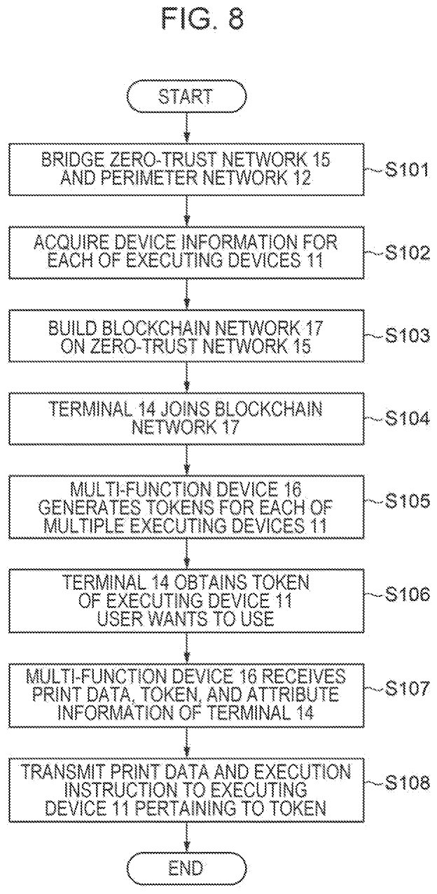

In the executing system 10 according to the exemplary embodiment, an execution process causing an executing device 11 to execute a predetermined process is performed according to an execution instruction from a terminal 14 as follows. FIG. 8 is a flowchart illustrating an example of the flow of the execution process in the exemplary embodiment.

First, as illustrated in FIG. 8, the CPU 221 connects the first interface 201 to the zero-trust network 15 and connects the second interface 202 to the perimeter network 12 (step S101). This enables the multi-function device 16 to bridge the zero-trust network 15 and the perimeter network 12.

Next, the CPU 221 acquires device information (such as the host name, IP address, MAC address, capacity, status, and rights information, for example) for each of the executing devices 11, and stores the acquired device information in the storage 224, for example (step S102).

Next, the CPU 221 builds the blockchain network 17 on the zero-trust network 15 (step S103). Specifically, for example, the CPU 221 defines 0th block information in a file or the like, initializes a blockchain on the basis of the file, and activates the blockchain with a private network ID to build the blockchain network 17 as a logical private network.

Next, a terminal 14 joins the blockchain network 17 on the basis of acquired information for joining the blockchain network 17 (step S104).

At this point, if there is an operational rule stipulating that an executing device 11 may be used if the terminal 14 is inside the building 19 (see FIG. 1) of the organization (for example, a company) where the terminal 14 is used, for example, the method by which the terminal 14 acquires information for joining the blockchain network 17 may be as follows.

Examples of the acquisition method include a method in which the terminal 14 acquires the information for joining by accessing a predetermined shared folder on the multi-function device 16, a method in which the executing device 11 transmits the information for joining to an email address belonging to a member of the company, and a method of acquiring the information for joining by scanning a two-dimensional barcode or the like.

Next, the multi-function device 16 generates tokens for each of the multiple executing devices 11 (step S105). The tokens are published on the blockchain network 17 as a token list and managed in a decentralized manner in a public ledger database on the blockchain network 17.

The tokens are also transferable between devices (specifically, the multi-function device 16 and the multiple terminals 14) on the blockchain network 17. Furthermore, upon joining the blockchain network 17, the terminals 14 become capable of referring to the token list generated by the multi-function device 16.

For example, the multi-function device 16 publishes the token list on a specific URL, allowing tokens to be obtained from the URL. The multi-function device 16 also displays the token list on the driver, enabling a user to obtain a token by selecting the executing device 11 the user wants to use from the driver.

The user checks the attribute information of the token through the terminal 14, and obtains a token of the executing device 11 the user wants to use (step S106).

The procedure for performing a print process in the executing device 11 at this point is as follows, for example. At the terminal 14, the token list generated by the multi-function device 16 is accessed. At the terminal 14, a token is selected and obtained.

The terminal 14 transmits print data, the token, and the attribute information of the terminal 14 to the multi-function device 16. Accordingly, the multi-function device 16 accepts the print data, token, and attribute information of the terminal 14 (step S107).

The multi-function device 16, upon determining that the executing device 11 pertaining to the token (the executing device 11 associated with the token) is usable on the basis of the attribute information of the terminal 14 and the rights information, capacity, status, and the like of the executing device 11 that the terminal 14 is attempting to transmit to, transmits the print data and an execution instruction to the executing device 11 (step S108).

As above, according to the exemplary embodiment, the CPU 221 connects the first interface 201 to the zero-trust network 15 and connects the second interface 202 to the perimeter network 12.

Next, the CPU 221 makes the list of tokens associated with each executing device 11 available for acquisition by the terminals 14 connected to the zero-trust network 15 (specifically, the blockchain network 17) as identification information identifying each executing device 11.

The CPU 221, upon accepting a token and a process execution instruction from a terminal 14 connected to the blockchain network 17, transmits the execution instruction over the perimeter network 12 to the executing device 11 associated with the token.

This arrangement makes it possible to cause the executing device 11 connected to the perimeter network 12 to execute a process according to the execution instruction from the terminal 14 connected to the zero-trust network 15 (specifically, the blockchain network 17).

Specifically, the CPU 221, upon accepting a token and a process execution instruction from a terminal 14 connected to the blockchain network 17, transmits the execution instruction over the perimeter network 12 to the executing device 11 associated with the token within the scope of the rights permitting use of the executing device 11 by the terminal 14, on the basis of attribute information in the terminal 14.

This arrangement makes it possible to cause the executing device 11 connected to the perimeter network 12 to execute a process within the scope of the rights permitting use of the executing device 11 by the terminal 14.

Note that in the exemplary embodiment, when usage restrictions on the executing devices 11 are set in the tokens, the CPU 221 makes the token list, in which usage restrictions on the executing devices 11 are set, available for acquisition by the terminals 14 connected to the zero-trust network 15.

In this case, it is possible to permit use of an executing device 11 by a terminal 14 within a specific scope.

### Exemplary Modifications

In the exemplary embodiment, a multi-function device 16 configured as an all-in-one machine is used as an example of an information processing system, but the configuration is not limited thereto. The example of an information processing system may also be a device such as a printer that only executes print processes, and an image forming device other than an all-in-one machine may be used. Moreover, the example of an information processing system is not limited to an image forming device, and may be any device which is connectible to each of the zero-trust network 15 and the perimeter network 12 and which is capable of bridging the zero-trust network 15 and the perimeter network 12.

In the exemplary embodiment, the executing devices 11 configured as all-in-one machines are used as an example of an executing device, but the configuration is not limited thereto. The example of an executing device may also be a device such as a printer that only executes print processes, and an image forming device other than an all-in-one machine may be used. Moreover, the example of an executing device is not limited to an image forming device, and a device that executes predetermined processes according to instructions from a user may be used.

The present disclosure is not limited to the exemplary embodiment above, and various modifications, alterations, and improvements are possible without deviating from the gist of the present disclosure. For example, the exemplary modifications described above may also be plurally combined, as appropriate.

In the exemplary embodiment, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

In the exemplary embodiment, the executing system 10 is described as a configuration formed by multiple devices, but may also be a configuration formed by a single device. In the exemplary embodiment, the information processing system is described as a configuration formed by a single device, but may also be a configuration formed by multiple devices. In other words, a “system” in the exemplary embodiment may be a configuration formed by multiple devices or a configuration formed by a single device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a first interface;
a second interface; and
a processor,
wherein the processor is configured to:
connect the first interface to a first network allowing any terminal to connect;
connect the second interface to a second network allowing a specific terminal to connect;
make identification information available for acquisition by a terminal connected to the first network, the identification information being used to identify an executing device that executes a predetermined process as the specific terminal connected to the second network; and
transmit, upon accepting the identification information and an execution instruction to execute the process from a terminal connected to the first network, the execution instruction over the second network to the executing device pertaining to the identification information.
   (((2)))

The information processing system according to (((1))), wherein the processor is configured to:
make the identification information available for acquisition by a terminal connected to a third network which is built on the first network and which allows a specific terminal to connect; and
transmit, upon accepting the identification information and an execution instruction to execute the process from a terminal connected to the third network, the execution instruction over the second network to the executing device pertaining to the identification information.
   (((3)))

The information processing system according to (((2))), wherein the processor is configured to transmit, upon accepting the identification information and an execution instruction to execute the process from a terminal connected to the third network, the execution instruction over the second network to the executing device pertaining to the identification information, within a scope of rights permitting use of the executing device by the terminal.

(((4)))

The information processing system according to any one of (((1))) to (((3))), wherein the processor is configured to:
make a list of tokens available for acquisition by a terminal connected to the first network, the tokens being the identification information associated with each executing device connected to the second network; and
transmit, upon accepting a token and the execution instruction from a terminal connected to the first network, the execution instruction over the second network to the executing device associated with the token.
   (((5)))

The information processing system according to (((4))), wherein the processor is configured to make a list of tokens, in which usage restrictions on the executing device are set, available for acquisition by a terminal connected to the first network.

(((6)))

An information processing program causing a computer to execute a process comprising:
connecting a first interface to a first network allowing any terminal to connect;
connecting a second interface to a second network allowing a specific terminal to connect;
making identification information available for acquisition by a terminal connected to the first network, the identification information being used to identify an executing device that executes a predetermined process as the specific terminal connected to the second network; and
transmitting, upon accepting the identification information and an execution instruction to execute the process from a terminal connected to the first network, the execution instruction over the second network to the executing device pertaining to the identification information.

What is claimed is:

1. An information processing system comprising:
a first interface;
a second interface; and
a processor,
wherein the processor is configured to:
connect the first interface to a first network allowing any terminal to connect;
connect the second interface to a second network allowing a specific terminal to connect;
make identification information available for acquisition by a terminal connected to the first network, the identification information being used to identify an executing device that executes a predetermined process as the specific terminal connected to the second network; and
transmit, upon accepting the identification information and an execution instruction to execute the process from a terminal connected to the first network, the execution instruction over the second network to the executing device pertaining to the identification information.

2. The information processing system according to claim 1, wherein the processor is configured to:
make the identification information available for acquisition by a terminal connected to a third network which is built on the first network and which allows a specific terminal to connect; and
transmit, upon accepting the identification information and an execution instruction to execute the process from a terminal connected to the third network, the execution instruction over the second network to the executing device pertaining to the identification information.

3. The information processing system according to claim 2, wherein the processor is configured to transmit, upon accepting the identification information and an execution instruction to execute the process from a terminal connected to the third network, the execution instruction over the second network to the executing device pertaining to the identification information, within a scope of rights permitting use of the executing device by the terminal.

4. The information processing system according to claim 1, wherein the processor is configured to:
make a list of tokens available for acquisition by a terminal connected to the first network, the tokens being the identification information associated with each executing device connected to the second network; and
transmit, upon accepting a token and the execution instruction from a terminal connected to the first network, the execution instruction over the second network to the executing device associated with the token.

5. The information processing system according to claim 4, wherein the processor is configured to make a list of tokens, in which usage restrictions on the executing device are set, available for acquisition by a terminal connected to the first network.

6. An information processing method comprising:
connecting a first interface to a first network allowing any terminal to connect;
connecting a second interface to a second network allowing a specific terminal to connect;
making identification information available for acquisition by a terminal connected to the first network, the identification information being used to identify an executing device that executes a predetermined process as the specific terminal connected to the second network; and
transmitting, upon accepting the identification information and an execution instruction to execute the process from a terminal connected to the first network, the execution instruction over the second network to the executing device pertaining to the identification information.

7. A non-transitory computer readable medium storing a program causing a computer to execute a process comprising:
connecting a first interface to a first network allowing any terminal to connect;
connecting a second interface to a second network allowing a specific terminal to connect;
making identification information available for acquisition by a terminal connected to the first network, the identification information being used to identify an executing device that executes a predetermined process as the specific terminal connected to the second network; and
transmitting, upon accepting the identification information and an execution instruction to execute the process from a terminal connected to the first network, the execution instruction over the second network to the executing device pertaining to the identification information.
